(19) United States
(12) Patent Application Publication
(10) Pub. No.: US 2012/0085237 A1
(43) Pub. Date: Apr. 12, 2012

(54) PASSIVE FAN FILTRATION SYSTEM (PFFS)

(75) Inventor: Sean E. Moore, West Point, GA (US)

(73) Assignee: Sean E. Moore, West Point, GA (US)

(21) Appl. No.: 13/269,012

(22) Filed: Oct. 7, 2011

Related U.S. Application Data
(60) Provisional application No. 61/391,083, filed on Oct. 8, 2010.

(51) Int. Cl. B01D 46/00

(52) U.S. Cl. 95/277

(57) ABSTRACT

An apparatus that attaches to a ceiling fan and extracts allergens and impurities from the air. The apparatus hangs off the front edge of the ceiling fan paddles [blades] and covers up to 100% of the paddle's body.

### TECHNICAL FIELD

Certain embodiments of the present disclosure generally relate to ceiling fan paddle air filters.

### BACKGROUND

Ceiling fan paddles contact 50% to 85% of the air they move.

This creates an opportunity for using a ceiling for air filtration.

### SUMMARY OF THE DISCLOSURE

Certain embodiments provide a method, system or device with a hypoallergenic coating, whereby allergens and impurities are extracted from the air.

### BRIEF DESCRIPTION OF THE DRAWINGS

FIG. 1 illustrates top view of filter (1), receding up to 20% from back of paddle (2) and is overhanging up to 20% in front of paddle. Front of filter/paddle is defined by side of paddle facing paddle rotation—back of filter/paddle is facing away from paddle rotation.

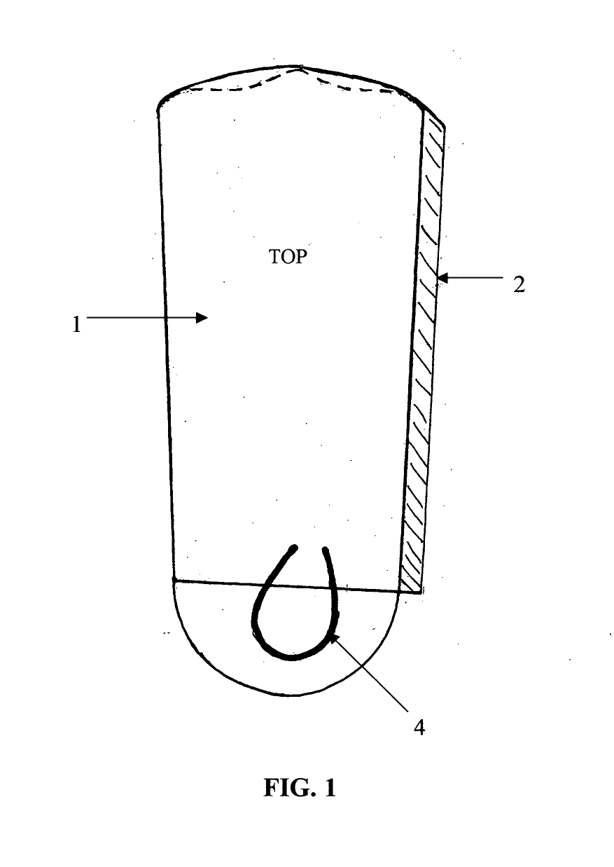

FIG. 2 illustrates side view of filter and paddle. (4) points to Retention Chord or Band.

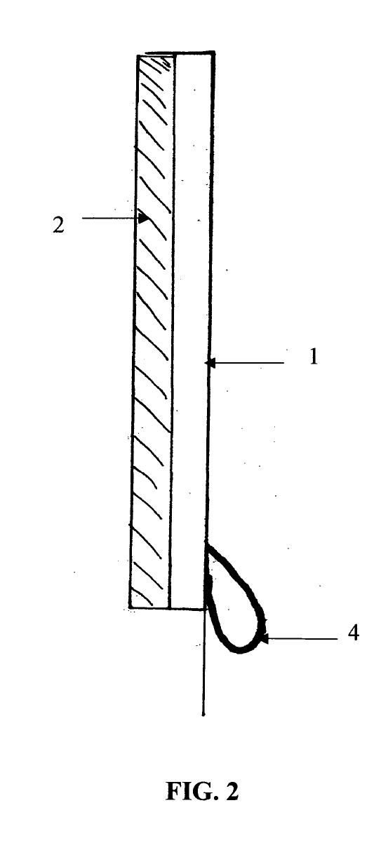

FIG. 3 illustrates bottom of filter (1). FIG. 3 also illustrates clip and Velcro placement areas (3) and paddle extending beyond filter up to 20%.

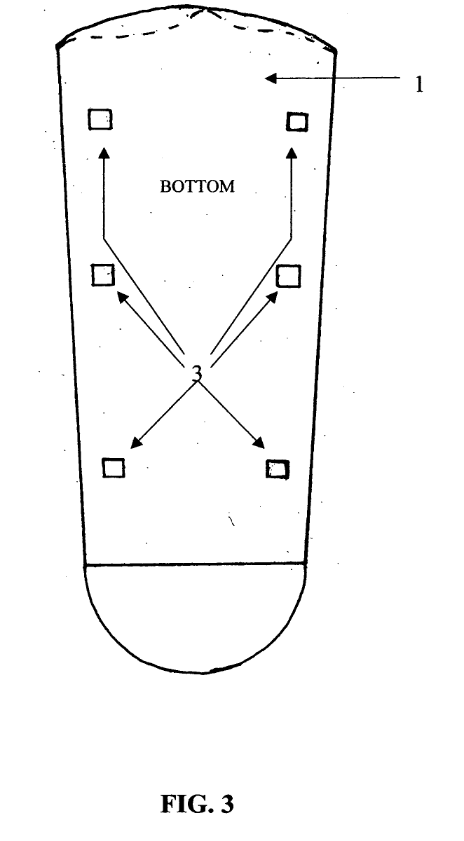

1. A method for capturing and extracting dust, impurities and allergens from the air, using the dynamics of a ceiling fan.

2. The method for extraction uses a plastic non-woven mesh material, coated with a hypoallergenic solution.

3. The material is attached to the ceiling fan paddles [blades] with clips, Velcro and a retention chord or band.
